(19) United States
(12) Patent Application Publication
(10) Pub. No.: US 2004/0096553 A1
(43) Pub. Date: May 20, 2004

(54) Ice cream cone drip guard

(76) Inventor: James E. Lynch, Beaufort, NC (US)

Correspondence Address: SUMMA & ALLAN, P.A., 11610 NORTH COMMUNITY HOUSE ROAD, SUITE 200, CHARLOTTE, NC, 28277, US

(21) Appl. No.: 10/300,224

(22) Filed: Nov. 20, 2002

(51) Int. Cl. A23G 1/00

(52) U.S. Cl. 426/132

(57) ABSTRACT

The invention is a cone drip guard formed from a flat sheet of material, or “blank”. The drip guard has an inner edge and an outer edge defining a hole in the blank through which an ice cream cone may be received. Finger-like projections known as “cone-gripping tabs” extend around the hole in the blank for gripping an ice cream cone and keeping the drip guard in place around a circumference of the cone while an ice cream cone is being consumed. The cone-gripping tabs include bend lines that enable the cone-gripping tabs to engage cones of various sizes. The invention further includes a collar around the cone-gripping tabs that extends outwardly to form a barrier between an upper portion of the ice cream cone and a lower portion of the ice cream cone. The barrier prevents dripping ice cream from falling on the consumer's hands or clothing.

### BACKGROUND OF THE INVENTION

The invention relates to methods and devices for preventing and lessening spills. In particular, the invention provides a means for substantially lowering the amount of ice cream that drips off a cone and lands in the surrounding area.

A recurring problem in eating ice cream and other frozen confections on an edible cone is that the ice cream melts and drips down the cone onto the person, clothes or surroundings of the consumer. The dripping or running ice cream results in a sticky, unsanitary situation that interferes with the pleasure of consuming the ice cream.

One attempt to remedy the untidiness in consuming melting ice cream in a cone has included wrapping the cone with towels or napkins, particularly towels and napkins made of paper. The problem with these towels and napkins is that they become overly moist with the melting ice cream and begin to stick to the consumer as well as sticking to the cone itself.

Other means of avoiding messy drips of melting ice cream include wrapping the outer surface of the cone in tightly fitting paper, but this practice often requires an adhesive to be applied to the paper to make it stick to the cone. The wrapper also requires peeling the paper back to eat the cone. The adhesives, in conjunction with partially melted ice cream running down the cone, tend to cause the wrapper to stick to the cone and interfere with consuming an edible cone.

A brief review of related patents illustrates problems encountered in designing a means for consuming melting ice cream or other frozen confections without the ice cream running down the cone.

U.S. Pat. No. 1,304,410 issued to J. A. Thornton on May 20, 1919 claims a conical receiver formed by rolling a flat sheet into a cone and closing the smaller end. An ice cream cone fits down into the receiver, and the receiver folds over into the cone. The problem with this design is that the ice cream cone is encompassed within the paper, requiring the consumer to peel the paper off the cone to eat the cone. As soon as the ice cream begins to melt, this conical receiver is difficult to remove from the cone. The conical receiver also requires some assembly and a means to hold the conical shape by gluing the paper together or cutting tabs and grooves into the paper, all of which add to the complexity of manufacturing the conical receiver.

U.S. Pat. No. 1,800,759 issued to L. F. Shean on Apr. 14, 1931 claims a cup holder fitting around the ice cream cone such that the cup may be squeezed together from its bottom, pushing the cone upward through the cup as it is consumed. The cup holder collects the melted ice cream which may be drunk from the cup holder. One problem with this design is that the ice cream cone must be pushed up from the bottom of the cup, and this force could cause the cone to crumble, exacerbating the problem of ice cream leaking from the cone.

U.S. Pat. No. 1,854,091 issued to J. C. Young on Apr. 12, 1932 claims a flat sheet cut into a design that may be wrapped around a cone in a fashion that provides a funnel type area near the top of the cone and tape-like wrap around the lower end of the cone. The design requires a specific cutting of the sheet and an adhesive treatment to the lower wrap that complicates manufacture. The adhesive strip wrapped around the cone diminishes the ability to remove the wrapper and eat the cone.

U.S. Pat. No. 1,920,995 issued to A. J. Legge on Aug. 8, 1933 claims an ice cream cone holder with a saucer like tray having a cone receiving aperture through it, and the tray portion is connected to a lower conical handle by an adhesive. The individual sections of the disclosed invention require specific manufacture as well as the application of an adhesive to ensure that the assembly holds together. These features are a problem in the field due to the extra materials required to fabricate the device and the cost of manufacture.

U.S. Pat. No. 2,948,452 issued to C. M. Grogan on Aug. 9, 1960 discloses an ice cream cone holder that is a molded plastic, open ended funnel type device that grips the cone with finger-like projections at the bottom of the cone. This device requires complicated manufacture and is not economically disposed after a single use.

U.S. Pat. No. 3,306,512 issued to E. Pagnini on Feb. 28, 1967 claims a circular saucer shaped device with a specifically sized hole cut out for receiving an ice cream cone. The saucer design requires a particular manufacturing process, and the device fails to allow more than one size of cone to be used with any particular saucer.

U.S. Pat. No. 4,226,355 issued to Fred Helfrich, Jr. on Oct. 7, 1980 discloses a funnel shaped device that fits inside an ice cream cone to direct the melting ice cream inside the cone. The main problem with this design is that the cone cannot be eaten until this inside liner is removed, and confining the melting ice cream inside the cone adds to the problem of a soggy cone that cannot maintain its functionality.

U.S. Pat. No. 4,718,594 issued to Michele Harazi on Jan. 12, 1988 claims an apparatus that catches melting ice cream as it falls or runs down a cone. The device comprises a concave dish with an upwardly extending rim along its outer edge. A hole is provided in the dish to receive an ice cream cone that is gripped by finger like projections encircling the hole. The cone receiving hole is also surrounded by an upwardly directed inside rim that directs melting ice cream into the concave dish. The main problem with this design is the complex manufacturing required to achieve the inner and outer rims, the gripping projections, and the concave dish area.

U.S. Pat. No. 4,720,037 issued to Theodore Alpert on Jan. 19, 1988 discloses a jacket that fits around an ice cream cone, similar to placing the ice cream cone in a cup and holding the cup instead of the cone. The device substantially covers the entire surface area of the cone such that manufacturing the device requires an excessive use of manufacturing materials. The enclosing cup would also interfere with eating the cone.

U.S. Pat. No. 5,152,454 issued to Joseph Warta on Oct. 6, 1992 discloses a flat sheet cut into an outer doughnut section having a central opening surrounded by slits. A tail section is provided which is attached to the doughnut section. An ice cream cone is inserted into the opening and gripped by tongue sections formed by the slits. The doughnut section is folded upward and connected by a slot and tab, creating a funnel area around the cone. The tail section is wrapped around a portion of the body of the cone and connected to itself with a second slot and tab configuration. The tail section forms a cone wrap for the consumer to hold without touching the cone, and the funnel section catches drips from the melting ice cream. The problems with this configuration include the complicated cutting and shaping required to manufacture the sheet. Each device is capable of handling only one type of cone so that different models would need to be manufactured for each different cone size and type. Consumers would also have trouble avoiding the wrapper when eating an edible cone.

U.S. Pat. No. 5,224,646 issued to Anthony Biancosino on Jul. 6, 1993 discloses a cup apparatus for holding an ice cream cone and drinking the melted ice cream that falls into the cup. The biggest problem with this design is that the consumer has another apparatus to purchase, manipulate while consuming the cone, and disposing afterwards. The fabrication does not lend itself to an economical single use device.

U.S. Pat. No. 5,899,353 issued to Jeffrey Sabin on May 4, 1999 discloses means for holding or transporting multiple ice cream cones in a box with cut outs for receiving the cones. This patent does not lend itself to a single use apparatus by a single consumer eating an ice cream cone.

U.S. Pat. No. 6,237,646 issued to David Rodman on May 29, 2001 discloses an ice cream cone holder comprising a cone shaped sleeve that incorporates inner and outer walls to confine melting ice cream falling off the cone. The problems with this design include manufacturing complexity and costs due to the series of folded walls required to practice the invention. The device is also designed to fit one type of cone at a time, so that different devices are necessary for each different type of cone marketed today.

U.S. Pat. No. 6,327,801 issued to Daniel Witkowski on Dec. 11, 2001 discloses a means for placing designs and advertisements on the inside of a wrapper fitted around the body of an cream cone and does not lend itself to catching drips of ice cream as envisioned herein.

Design Pat. No. 426,047 issued to Henry Kurz on Jun. 6, 2000 and Design Pat. No. 382,085 issued to Robert Sotile on Aug. 12, 1997 each disclose funnel type designs for holding ice cream cones and catching drips. The problem with these designs is that the dimensions fit only one type of cone unless a different size is specifically manufactured for different cones. These devices also cover most of the outer surface area of an ice cream cone, interfering with eating the cone.

The above referenced patents indicate that there is a need for an ice cream cone drip guard that is easy to manufacture in an economical fashion. The drip guard should incorporate a means for accommodating any size or shape of ice cream cones and should not interfere with the enjoyment of consuming an edible cone. The apparatus would preferably protect the consumer from dripping ice cream without requiring a completely enclosed cone that must be unwrapped or removed from a container to be eaten.

### OBJECT AND SUMMARY OF THE INVENTION

It is therefore an object of the present invention to provide an ice cream cone drip guard that protects a consumer from dripping and running ice cream or other frozen confections consumed in an edible cone. The invention further provides an ice cream cone drip guard that accommodates different sizes and shapes of ice cream cones while maintaining a single structure, stays in place securely around a cone, is easy to manufacture, is suitable for a single use, and is easily disposed.

The invention claimed herein meets its objectives with an ice cream cone drip guard that comprises a flat blank with a hole to receive an ice cream cone or other dripping object. The blank fits around a circumference of the ice cream cone and provides a barrier between the melting ice cream and the consumer's hands, as well as the surroundings. In particular, the invention is a blank for an ice cream cone drip guard that comprises a hole for receiving an ice cream cone, and the blank further comprises finger-like tabbed projections pointing into the hole for gripping the inserted ice cream cone. The tabbed projections, also referred to herein as “cone-gripping tabs”, are formed by providing separable scores or slits from the inner edge toward the outer edge so that the cone-gripping tabs have edges on either side and share the inner edge defining the hole in the blank. The cone-gripping tabs are joined to each other by a series of break points connecting each tab to its neighboring tabs at points on its side edges. These break points are segments of the blank that are uncut and form a perforation point along the sides of each cone-gripping tabs. The cone-gripping tabs also have bend lines across them with the bend lines encircling the hole in the blank. Each bend line allows the cone-gripping tabs to bend to contact an ice cream cone placed inside the hole. A small or medium sized ice cream cone will bend the cone-gripping tabs along an innermost bend line, and a large ice cream cone will bend the cone-gripping tabs along an outermost bend line. If necessary to accommodate a large cone, the break points in the blank may break loose as the large cone is inserted, allowing the cone-gripping tabs to accept a cone with an especially large circumference without tearing. The ice cream cone drip guard of the present invention is substantially flat, can be manufactured by cutting processes without complicated molding or assembly, and can be stacked in great numbers while fitting into a standard package of ice cream cones.

The foregoing and other objects and advantages of the invention and the manner in which the same are accomplished will become clearer based on the following detailed description taken in conjunction with the accompanying drawings.

### BRIEF DESCRIPTION OF THE DRAWINGS

FIG. 1 is a side view of the claimed invention in use with an ice cream cone held by a consumer, illustrating the ability of the invention to provide a barrier between the melting ice cream and the surrounding areas.

FIG. 2 is a top planar view of the preferred embodiment of the claimed invention, illustrating the circular flat blank with a concentric hole defining a collar, concentric bend lines for accommodating different sizes of cones in the hole, and edges of the cone-gripping tabs formed by scores or cuts in the blank extending from the inner edge of the hole toward the outer edge of the drip guard.

FIG. 3 is a cross section view along the center of a cone-gripping tab into the collar region of the device, illustrating the notches formed by the concentric bend lines in the blank.

FIG. 4A illustrates a cross section along the center of a cone-gripping tab in contact with a small or medium sized cone such that the cone-gripping tab bends along an innermost concentric bend line to accommodate the cone and maintain contact with the surface of the cone.

FIG. 4B illustrates a cross section along the center of a cone-gripping tab in contact with a large sized cone such that the cone-gripping tab bends along an outermost concentric bend line to accommodate the cone and maintain contact with the surface of the cone.

### DETAILED DESCRIPTION OF THE INVENTION

The present invention will now be described more fully hereinafter with reference to the accompanying drawings, in which a preferred embodiment of the invention is shown. This invention, however, may be embodied in many different forms and should not be construed as limited to the embodiments set forth herein. Rather, these embodiments are provided so that this disclosure will be thorough and complete, and will fully convey the scope of the invention to those skilled in the art.

The invention may comprise many different shapes and sizes. The mechanical configuration may vary depending upon the use at hand. The reference numbers in this detailed description correlate to the Figures, all of which portray a circular drip guard. The reference numbers are for the ease of the reader only and are not intended to limit the shape or configuration of the drip guard to those elements portrayed in any drawing. Like numbers refer to like elements throughout the specification.

The invention is a cone drip guard that provides a barrier between a dripping object, such as melting ice cream, and the person or surroundings of the person holding the dripping object or eating ice cream in a cone. The cone drip guard is made of a substantially flat sheet, commonly referred to in the industry as a blank. The cone drip guard is preferably made out of absorbent material, such as paper or fabric. It will be understood, of course, that other materials (e.g., plastic) are suitable, too. The cone drip guard may be accentuated with designs, such as printing, patterns, graphics, and even colors. Scalloped edges along the sheet's outer edge are especially pleasing.

The drip guard includes a substantially flat sheet (10) having an outer edge (12) and an inner edge (12). The inner edge (11) of the sheet defines a hole that can receive a dripping object therein, such as a cone (30), especially an ice cream cone. In particular, the sheet (10) includes a gripping skirt (17), which functions to secure the sheet to the dripping object or cone and thereby prevent drips from running entirely down the cone and reaching a holder's hand. In this regard, the sheet should be sufficiently wide to substantially prevent melting ice cream or some other dripping matter from dripping past the sheet onto the holder's hand or clothing. An exemplary drip guard has a diameter of between about 4 and 5 inches.

Accordingly, the sheet includes an innermost bend line (15) surrounding the inner edge (12) between the inner edge (12) and the outer edge (11), for bending in response to the pressure of an object to be gripped in the sheet. The sheet further comprises an outermost bend line (16) surrounding the innermost bend line (15) between the innermost bend line and the outer edge (11) of the sheet, for bending in response to objects larger than those that bend the innermost bend line. A plurality of score lines (18a-18p) extends from the inner edge (12) toward the innermost bend line, the outermost bend line, and the outer edge of the sheet. The score lines enhance the bending of the innermost and outermost bend lines to more securely grip dripping objects of various sizes. In this regard, at least one score line extends to the innermost bend line. Alternatively, at least one score line may extend to the outermost bend line, or each score line may extend to the outermost bend line. These score lines delineate each of the cone-gripping tabs (20a-20p) positioned around the hole in the sheet.

The term cone-gripping tabs, as used herein, means finger-like projections extending from the body of the flat sheet toward the inner edge. These cone-gripping tabs are formed by discontinuously scoring the sheet from points along the inner edge (12) to points in the direction of the outer edge (11). These discontinuous scores in the sheet may cut the sheet all the way through to create pairs of edges (18a, 19a-18p,19p) in the body of the sheet to define the sides of each cone-gripping tab.

Embodiments utilizing fully cut score lines have edge pairs that are separated by segments of the flat sheet that are not cut all the way through the sheet. These segments characterize as discontinuous the cuts in the sheet defining the sides of the cone-gripping tabs. These discontinuities, or uncut portions of the sheet, define break points (23a-23p) along which each cone-gripping tab is connected to the adjacent cone-gripping tabs on either side. The break points (23a-23p) further define beginning points and endpoints for the scores, or possibly cuts, in the sheet that create the edge pairs on the side of each cone-gripping tab. The edge pairs are formed by scoring or cutting the sheet such that a first edge extends from points on the inner edge to points between the inner edge and the break point, and a second edge extends toward the outer edge of the sheet from points between the break point and the outer edge.

The cone-gripping tabs (20a-20p) between the outer edge (11) and the inner edge (12) of the sheet collectively comprise the gripping skirt (17). Each cone-gripping tab (20a-20p) has a central fold segment so that the plurality of fold segments on the cone-gripping tabs defines a centrally positioned innermost bend line (15) within the gripping skirt. The gripping skirt (17) may optionally include an outermost bend line (16) that defines the width of the gripping skirt (17) from the inner edge (12).

The term “bend lines” as used herein are indentions in the flat sheet that do not cut through the sheet but provide lines across the surface of the sheet at which the thickness of the sheet is at a minimum and therefore easier to fold along these lines, as illustrated in FIG. 3.

The gripping skirt is formed in the sheet by score lines (18a-18p, 19a-19p) that extend outwardly from the sheet's inner edge (12) to its outer edge (11). These score lines, which can be full cuts, partial cuts, perforations, or folds, effectively define a plurality of cone-gripping tabs (20a-20p). The score lines are typically radial score lines (i.e., extending outwardly from the inner edge of a substantially circular sheet). Especially preferred are discontinuous slits, as noted above, which define break points that connect adjacent cone-gripping tabs. In embodiments with a circular sheet, the sheet may be described as having a plurality of radial score lines extending from the inner edge to define a substantially circular, concentric gripping skirt.

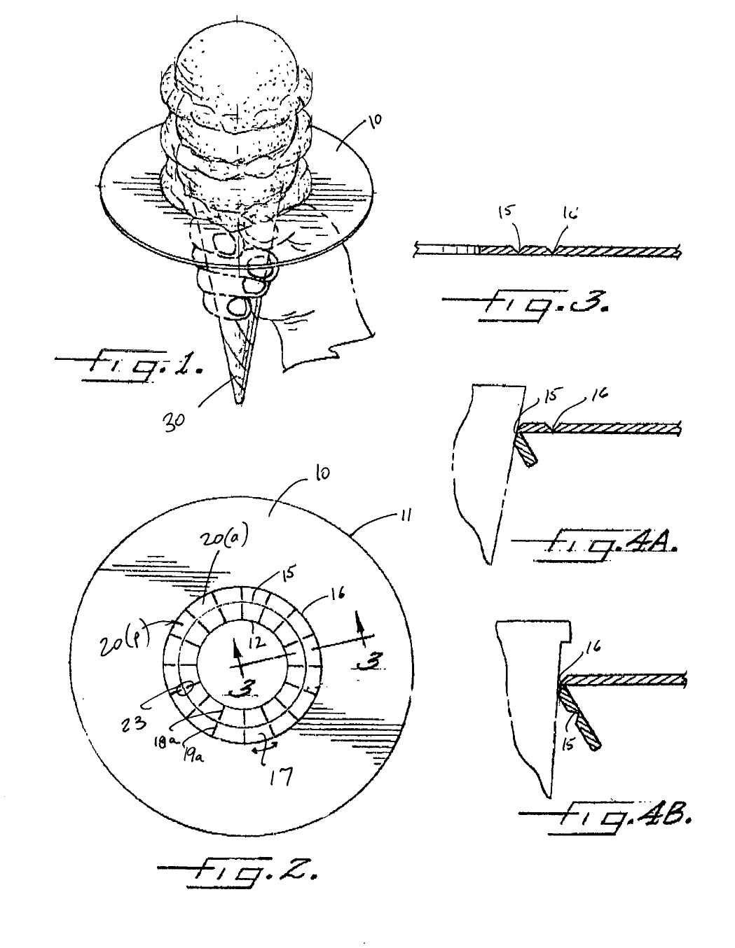

The gripping skirt serves the purpose of securing the sheet (10) to a cone (30) inserted into the hole of the sheet, as illustrated in FIG. 1. The cone-gripping tabs encircle the inserted cone and hold the sheet, or blank, in place around the cone. When the sheet is engaged with a smaller cone, the gripping skirt bends at its innermost bend line. When the sheet is engaged with a larger cone, the gripping skirt bends at its outermost bend line.

Stated otherwise, the cone-gripping tabs, which form the gripping skirt, include individual fold segments. When the sheet is engaged with a small cone, the cone-gripping tabs bend at their respective fold segments to secure the sheet to the cone, as illustrated in FIG. 4A. When the sheet is engaged with a larger cone, as illustrated in FIG. 4B, the cone-gripping tabs bend at their base, which may coincide with an outermost bend line, to secure the sheet to the cone.

The invention may be further described by reference to FIG. 2. FIG. 2 shows the cone drip guard formed of a substantially flat circular sheet (10), or blank, having an outer edge (11) and an inner edge (12) that defines a circular, concentric hole in the blank. An innermost circular, concentric bend line (15), positioned between the inner edge (12) and the outer edge (11) of the blank, surrounds the hole in the blank. An outermost circular, concentric bend line (16) surrounds the innermost concentric bend line (15) and is positioned between the innermost concentric bend line (15) and the outer edge (11) of the sheet (10). A plurality of cone-gripping tabs (20a-20p) encircles the hole between the outermost concentric bend line (16) and the inner edge (12) of said sheet. The outermost bend line (16) and the inner edge (12) of the sheet define the length of each cone-gripping tab (20) encircling the hole in the sheet.

When the flat circular sheet is engaged with a smaller cone, as in FIG. 4A, the cone-gripping tabs bend at their innermost concentric bend line (15) to secure the sheet (10) to the cone (30). When the sheet is engaged with a larger cone, as in FIG. 4B, the cone-gripping tabs bend at the outermost circular, concentric bend line (16) to secure the sheet to the cone.

The cone-gripping tabs of FIG. 2 are connected to one another at break points defined by uncut portions of the sheet or blank. These break points (23a-23p) may be positioned on the innermost concentric bend line (15) to add rigidity to the cone-gripping tabs and enable a more secure fit to small or medium cones.

Preferably, the sheet's inner edge (12), innermost bend line (15), outermost bend line (16), and outer edge (11) define concentric circles of increasing diameters, as shown in FIG. 2. Those of ordinary skill in the art will note that in such embodiments the gripping skirt (17) defines an annulus around a substantially circular, concentric hole.

The ice cream cone drip guard of the present invention can be of various sizes, dimensions, and shapes and may include any desired number of cone-gripping tabs cut into the sheet. A preferred embodiment includes a substantially flat, circular blank (10) with an outside diameter 4.125 inches. The inner edge (12) defines a hole in the blank with the hole having a radius from absolute center of 0.5625 (9/16) inch. The innermost concentric bend line (15) comprises a circle with a radius of 0.8125 (13/16) inches from the absolute center of the drip guard, so that points on the innermost bend line (15) are 0.25 (¼) inch from points on the inner edge (12). The outermost concentric bend line (16) comprises a circle with a radius of 0.9375 (15/16) inch from the absolute center of the hole of the drip guard, so that points on the outermost bend line are 0.125 (⅛) inches from points on the innermost bend line (15). These dimensions result in a collar portion of the blank defined so that points on the outer edge are 1.125 (1⅛) inches from points on the outermost bend line.

The substantially flat construction is useful to simplify manufacturing of the drip guard, and the flat drip guards are easily stacked one upon the other for packing and shipping with packages of ice cream cones. The stacked, flat drip guards are also easy to dispense for use by consumers.

The ice cream cone drip guard of this invention is preferably a single use drip guard that the consumer can easily remove and discard. Paper drip guards can be easily dispensed in standard trash cans or even recycle bins.

The drip guard is unique in its single sheet construction that requires no adhesives, and no specialized molds for fabrication.

This specification refers to “ice cream” in the broadest sense of frozen foods that are consumed in a cone and may include traditional ice cream, ice milk, frozen yogurt, nondairy frozen desserts, flavored ice, and the like.

As used in this specification, the term “blank” means a flat sheet of material sufficiently pliable to bend at appropriate points when pressure is applied and simultaneously rigid enough to maintain its original shape when such pressure is absent. The blank must be capable of being cut all the way through by traditional means and capable of supporting an indention in its surface, along which the blank may fold if necessary.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A cone and cone drip guard for preventing melting ice cream from running entirely down the cone and reaching a holder's hand, comprising:
a sheet having an outer edge and an inner edge, said inner edge defining a hole in said sheet;
a plurality of cone-gripping tabs between said outer edge of said sheet and said inner edge of said sheet, wherein each said cone-gripping tab includes a central fold segment; and
a cone extending through the hole defined by said sheet, wherein said plurality of cone-gripping tabs secure said sheet to said cone.

2. A cone drip guard according to claim 1, wherein said sheet is substantially flat.

3. A cone drip guard according to claim 2, wherein said cone-gripping tabs secure said sheet to said cone by folding along the respective fold segments.

4. A cone drip guard according to claim 2, wherein said sheet is a substantially circular sheet and wherein said inner edge of said sheet defines a substantially circular, concentric hole.

5. A cone drip guard according to claim 4, further comprising a substantially circular, concentric bend line that defines the length of said plurality of cone-gripping tabs, said concentric bend line positioned between said inner edge of said sheet and said outer edge of said sheet.

6. A cone drip guard according to claim 1, further comprising a bend line that defines the length of said plurality of cone-gripping tabs, said bend line positioned between said inner edge of said sheet and said outer edge of said sheet.

7. A cone drip guard for preventing melting ice cream from running entirely down the cone and reaching a holder's hand, comprising:
a sheet with an outer edge and an inner edge, said inner edge defining a hole in said sheet;
a plurality of score lines extending outwardly from said inner edge of said sheet toward said outer edge of said sheet, said plurality of score lines defining a gripping skirt between said inner edge and said outer edge;
an innermost bend line positioned within said gripping skirt.

8. A cone drip guard as in claim 7, wherein:
said sheet comprises a substantially circular blank;
said inner edge of said sheet defines a substantially circular, concentric hole; and
said plurality of score lines extends radially from said inner edge to define a substantially circular, concentric gripping skirt.

9. A cone drip guard as in claim 7, wherein said plurality of score lines comprise discontinuous slits in said sheet, said discontinuous slits defining cone-gripping tabs.

10. A cone drip guard as in claim 7, further comprising an outermost bend line surrounding said innermost bend line, said outermost bend line and said inner edge of said sheet defining the width of said gripping skirt.

11. A cone drip guard as in claim 10, wherein said inner edge of said sheet, said innermost bend line, said outermost bend line, and said outer edge of said sheet define concentric circles of increasing diameters.

12. A cone drip guard as in claim 11, further comprising a cone, said gripping skirt securing said sheet to said cone.

13. A cone drip guard as in claim 7, further comprising an ice cream cone, said gripping skirt securing said sheet to said cone.

14. A cone drip guard as in claim 13, wherein said sheet is sufficiently wide to substantially prevent melting ice cream from dripping past said sheet.

15. A drip guard, for catching drips from dripping objects placed in the drip guard, comprising:
a substantially flat sheet having an outer edge and an inner edge, said inner edge defining a hole in said flat sheet for receiving a dripping object therein;
an innermost bend line surrounding said inner edge, said innermost bend line positioned between said inner edge and said outer edge, for bending in response to the pressure of an object to grip the object;
an outermost bend line surrounding said innermost bend line, said outermost bend line positioned between said innermost bend line and said outer edge of said sheet, for bending in response to objects larger than those that bend the said innermost bend line;
a plurality of score lines extending from said inner edge, towards said innermost and outermost bend lines for enhancing the bending of said innermost and outermost bend lines to thereby grip an object more securely.

16. A cone drip guard according to claim 15, wherein at least one score line extends to said innermost bend line.

17. A cone drip guard according to claim 15, wherein at least one said score line extends to said outermost bend line.

18. A cone drip guard according to claim 15, wherein each said score line extends to said outermost bend line.

19. A cone drip guard according to claim 15, wherein:
said sheet is a substantially circular blank;
said inner edge of said blank defines a substantially circular, concentric hole; and
said innermost and outermost bend lines define substantially concentric circles around said inner edge.

20. A cone drip guard according to claim 19, wherein said plurality of score lines are radial score lines.

21. A cone drip guard according to claim 15, wherein said score lines comprise discontinuous slits in said sheet.

22. A cone drip guard for preventing melting ice cream from running entirely down the cone and reaching a holder's hand, comprising:
a substantially circular blank having an outer edge and an inner edge, said inner edge defining a concentric hole in said blank;
an innermost concentric bend line surrounding the hole in said blank, said innermost concentric bend line positioned between said inner edge and said outer edge of said blank;
an outermost concentric bend line surrounding said innermost concentric bend line, said outermost concentric bend line positioned between said innermost concentric bend line and said outer edge of said sheet;
a plurality of cone-gripping tabs between said outermost concentric bend line and said inner edge of said sheet.

23. A cone drip guard according to claim 22, wherein said blank comprises a plurality of break points that attach adjacent cone gripping tabs to one another.

24. A cone drip guard according to claim 23, wherein each said break point is positioned on said innermost concentric bend line.

25. A cone drip guard according to claim 22, wherein said cone-gripping tabs encircle a cone to hold said blank around said cone.

26. A cone drip guard according to claim 25, wherein said cone-gripping tabs bend along said innermost concentric bend line.

27. A cone drip guard according to claim 25, wherein said cone-gripping tabs bend along said outermost concentric bend line.

28. A cone drip guard according to claim 25, wherein the diameter of said blank is sufficient to substantially prevent melting ice cream from dripping past said sheet.

29. A cone drip guard according to claim 22, wherein said blank comprises absorbent material.

30. A cone drip guard according to claim 22, wherein said blank comprises paper.

31. A cone drip guard according to claim 22, wherein said blank has a printed design thereon.

32. A cone drip guard according to claim 22, wherein said blank is scalloped along its outer edge.

33. A cone drip guard according to claim 22, wherein the diameter of said blank is between about 4 and 5 inches.
